(19) United States
(12) Patent Application Publication
(10) Pub. No.: US 2026/0365801 A1
(43) Pub. Date: Nov. 19, 2026

(54) MOISTURE CURE OF ANHYDRIDE FUNCTIONALIZED POLYMERS WITH POLYMER-BASED EPOXY SILANES AS CROSS-LINKERS

(71) Applicant: Dow Global Technologies LLC, Midland, MI (US)

(72) Inventors: Chao He, Shanghai (CN); Wanfu Ma, Shanghai (CN); Allan Walter Mc Lennaghan, Tarragona (ES); Xiaomei Song, Shanghai (CN); Juan C. Tuberquia, Pearland, TX (US); Alexander Williamson, Rosharon, TX (US); Cristina Serrat, Sugar Land, TX (US)

(21) Appl. No.: 19/111,525

(22) PCT Filed: Dec. 14, 2022
(86) PCT No.: PCT/CN2022/139055

§ 371 Date: Mar. 13, 2025

(51) Int. Cl. C08J 3/24; C08L 23/30

(52) U.S. Cl. CPC C08J 3/246; C08L 23/30

(57) ABSTRACT

Composition comprises at least the following components a and b: a) an anhydride functionalized olefin-based polymer; b) a polymer-based epoxy silane comprising the following i) and ii) i) at least one epoxy group selected from the following ia) through ic): ia), where R¹, R² and R³ are each independently H or an alkyl, and the asterisk (*) represents the remainder of the polymer-based epoxy silane, the following asterisks mean the same; where R¹ and R³ are each independently H or an alkyl, the term Ring represents a ring structure comprising more than 5 carbon atoms; or ic) a combination of ia) and ib); ii) at least one siloxane group selected from the following iia) through iic): iia) Si(OR)(X¹)(X²), where X¹ and X² are each independently an alkyl group or an alkoxy group, R is an alkyl group; iib) Si(OR)(X¹), where X is an alkyl group or an alkoxy group, R is an alkyl group; or iic) a combination of iia) and iib); and wherein the polymer-based epoxy silane comprises at least 2 silicon atoms. The composition can provide a wide processing windows (long time operation window at high temperature), and more eco-friendly polymer formulations that provide for a better controlled of the curing process.

### BACKGROUND OF THE INVENTION

Thermoplastics usually need to be cured, before being used in a high temperature application, since the plastic will melt when the temperature is higher than the melting temperature of the plastic. Many curing chemistries were developed, such as sulphuration curing, peroxide curing and moisture curing. However, these curing chemistries will limit the processibility of the thermoplastic, to avoid the undesired curing during a process, such as an extrusion process. For example, during an extrusion, the extrusion temperature needs to be reduced, and/or the residence time in the extruder needs to be reduced, to avoid the early stage curing (scorch) of polymers formulated with a sulfur or a peroxide or a moisture curing agent. The polymer formulations containing these curing agents are typically not stable at high temperatures, for the time needed to complete the process at hand. Thus, there is a need for new polymer formulations that have good curing efficiency and a wide process window—stable at processing temperatures greater than 100 °C.

Also, in hot melt adhesive (HMA) applications, there is a strong need for a long time, high temperature operation window. The incumbent curing chemistry in HMA is POLYURETHANE REACTIVE (PUR), which uses NCO chemistry. However, PUR has two major disadvantages; one is the toxicity of NCO and the other is the gel issue due to the high reactivity of NCO. Thus, there is a need to replace PUR with more environmentally friendly polymer formulations that provide better controlled of the curing process.

U.S. Pat. No. 5,210,150 discloses moisture-curable, melt-processible adhesives obtained by reacting certain ethylene copolymers containing an n-alkyl acrylate and a carefully limited amount of a carboxylic acid, with a stoichiometric amount of an epoxy-silane (see abstract). However, as shown in the data of the present invention (see Experimental section), acids tend to readily react with epoxy, and catalyze the condensation of silane to form crosslinking in the polymer system, especially at high temperature.

U.S. Pat. No. 9,562,149 discloses a release coating composition comprising a polyorganosiloxane (A) having alkenyl groups, a crosslinking agent (B) having organohydrogensiloxane groups, a catalyst for the hydrosilylation reaction between (A) and (B), and an anchorage additive for enhancing the adhesion of the composition to a polymer film substrate. The anchorage additive is the reaction product of a fluid polyorganosiloxane (C) containing at least one alkenyl group and at least one silanol group, with a hydrolysable silane (D) containing at least one epoxide group. The curable silicone release coating composition can be applied to a substrate and cured. The substrate is known as a ‘liner’ retaining a label, which liner can be, for example, paper or a polymer film. See abstract.

Additional polymer formulations are disclosed in the following references: U.S. Pat. Nos. 8,399,571, 8,569,417 and U.S. Publication 2020/0216730. However, as discussed above, there remains a need for polymer formulations and related curing processes, that provide a wide processing windows (long time operation window at high temperature). There is also a need for more eco-friendly polymer formulations that provide for a better controlled of the curing process. These needs have been met by the following invention.

### SUMMARY OF THE INVENTION

A first composition comprising at least the following components a and b:
a) an anhydride functionalized olefin-based polymer;
b) a polymer-based epoxy silane comprising the following i) and ii):
   i) at least one epoxy group selected from the following ia) through ic):
ia)

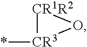

where R1, R2 and R3 are each independently H or an alkyl, and the asterisk (*) represents the remainder of the polymer-based epoxy silane,
ib)

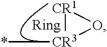

where R1 and R3 are each independently H or an alkyl, the term “Ring” represents a ring structure comprising ≥5 carbon atoms, and the asterisk (*) represents the remainder of the polymer-based epoxy silane, or ic) a combination of ia) and ib);
ii) at least one siloxane group selected from the following iia) through iic):
iia)

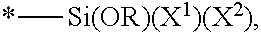

where X1 and X2 are each independently an alkyl group or an alkoxy group, R is an alkyl group, and the asterisk (*) represents the remainder of the polymer-based epoxy silane,
iib)

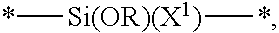

where X1 is an alkyl group or an alkoxy group, R is an alkyl group, and each asterisk (*) independently represents the respective remainder of the polymer-based epoxy silane; or iic) a combination of iia) and iib); and
wherein the polymer-based epoxy silane comprises ≥2 silicon atoms.

### DETAILED DESCRIPTION OF THE INVENTION

New compositions, and crosslinking processes using the same, have been discovered, which provide low viscosity formulations with good thermal stability and excellent high temperature operation windows (for example, viscosity <75,000 mPa·s after 3 hours at 120 °C, and/or viscosity <12,000 mPa·s after 3 hours at 177 °C), and high Shear Adhesion Failure Temperature (SAFT)>150 °C or >170 °C after curing for 7 days at 35 °C/85% RH. In particular, high temperature resistant, hot melt adhesives (HMAs) have been discovered, along with the cure processes for the same.

It was discovered that when a polymer-based epoxy-silane is mixed with an anhydride functionalized polymer, at high temperature, the anhydride does not react with epoxy-silane to any significant extent. As such, the viscosity of the polymer composition is stable for a long time at high temperature. After the composition (physical blend) is prepared, it can be moisture cured in a controlled manner. It was discovered that, in the presence of moisture, the anhydride will convert to a di-acid form, and one acid group will react with epoxy to form the chemical bond between polymer and epoxy-silane, and the other acid group will work as an in-situ catalyst, to catalyze the hydrolysis/condensation reactions of silane to form a crosslinking site. See for example, Scheme 1 below. Moreover, some moisture curing catalysts, such as dibutyltin dilaurate (DBTDL, CAS: 77-58-7), may be added to improve cure.

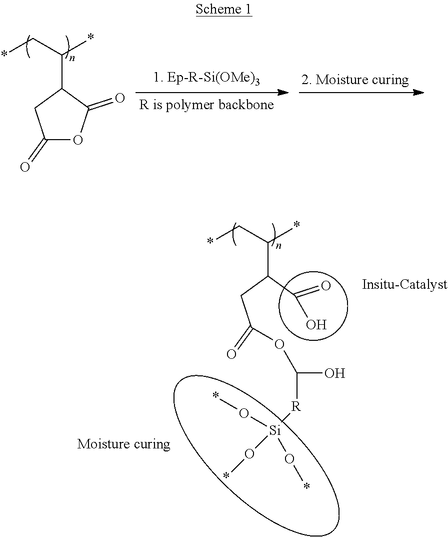

As discussed above, a first composition is provided comprising at least the following components a and b: a) an anhydride functionalized olefin-based polymer as discussed above, and b) a polymer-based epoxy silane as discussed above. The first composition may comprise a combination of two or more embodiments, as described herein. Each component a and b may, independently, comprise a combination of two or more embodiments, as described herein.

Note, as used herein, in reference to the polymer-based epoxy silane, R1=R¹, R2=R², R3=R³, and so on. Also, RA=R^{A}, RB=R^{B}, and so on In regard to the number of carbon atoms in a chemical group, the notation, for example, “C1-C5,” where “1 through 5” represents consecutive numbers from 1 to 5, refers to “from 1 to 5 carbon atoms” that may be present in the chemical group. An “alkyl” group may be linear, branched, cyclic, or any combination thereof. An “alkenyl” group may be linear, branched, cyclic, or any combination thereof. A “hydrocarbylene” group may be linear, branched, cyclic, or any combination thereof. A “heterohydrocarbylene” group may be linear, branched, cyclic, or any combination thereof.

In one embodiment, or a combination of two or more embodiments, each described herein, the polymer-based epoxy silane further comprises one or more of the following chemical groups a) through i):
a) —(CR¹R²—CR³R⁴)—, where each of R1, R2, R3, R4 is independently H or an alkyl, and further each of R1, R2, R3, R4 is the same, and further R1=R2=R3-R4=H; b) —(SiR1R2-O)—, where each of R1, R2 is independently an alkyl, and further R1=R2, and further R1=R2=a C1-C5 alkyl group, further a C₁-C₄ alkyl group, further a C₁-C₃ alkyl group, further a C1-C2 alkyl group, further a methyl group; c) —(Si(R)(CR1=CR2R3))—, where R is an alkyl and further a C₁-C₅ alkyl group, further a C₁-C₄ alkyl group, further a C₁-C₃ alkyl group, further a C1-C2 alkyl group, further a methyl group, and each of R1, R2, R3 is independently H or an alkyl, and further each of R1, R2, R3 is the same, and further R1=R2=R3=H; d) —(CR¹R²—CR³(CR⁴=CR⁵R⁶))—, where each of R1, R2, R3, R4, R5, R6 is independently H or an alkyl, and further each of R1, R2, R3, R4, R5, R6 is the same, and further R1=R2=R3=R4=R5=R6=H; e) amide; f) ester; g) urethane; h) —(CR1R2-CR3R4)-, where each of R1, R2, R3 is independently H or an alkyl, and further each of R1, R2, R3 is the same, and further R1=R2=R3=H, and R4 is an aryl group, and further R4 is a phenyl group; or i) any combination thereof, and
   wherein each chemical group is derived from one or more monomers; and when present, each chemical group is present in at least two repeating units within the polymer-based epoxy silane. In a further embodiment, the polymer-based epoxy silane further comprises one or more of the following chemical groups a) through d) or i).

In one embodiment, or a combination of two or more embodiments, each described herein, the polymer-based epoxy silane comprises at least one of the following structures T1a through T1c:
T1a)

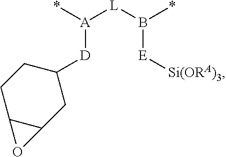

where D is a hydrocarbylene or a heterohydrocarbylene; E is a hydrocarbylene or a heterohydrocarbylene; A is —(CR1R2-CR3)- or —(O—SiR4)-, where R1, R2, R3 are each independently H or an alkyl, and R4 is an alkyl; B is —(CR5R6-CR7)- or —(O—SiR8)-, where R5, R6, R7 are each independently H or an alkyl, and R8 is an alkyl; and wherein at least one of D, E, A or B comprises at least one Si atom; RA is an alkyl, L is a divalent linker group, and each asterisk (*) independently represents the respective remainder of the polymer-based epoxy silane;
T1b)

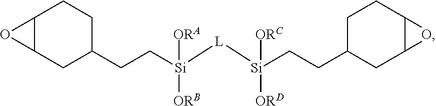

where RA, RB, RC and RD are each independently an alkyl, and L is a divalent linker group;
T1c) a combination of T1a and T1b.

In one embodiment, or a combination of two or more embodiments, each described herein, for the T1a structure, L comprises C, Si, or a combination thereof. In one embodiment, or a combination of two or more embodiments, each described herein, for the T1b structure, L comprises C, Si, or a combination thereof.

In one embodiment, or a combination of two or more embodiments, each described herein, the polymer-based epoxy silane comprises structure T1a. In one embodiment, or a combination of two or more embodiments, each described herein, the polymer-based epoxy silane comprises one of the following structures T3a1, T3a2, T3a3, T3a4, T3a5 or T3a6, each as described below (see item H2] below).

In one embodiment, or a combination of two or more embodiments, each described herein, the polymer-based epoxy silane comprises structure T1b.

In one embodiment, or a combination of two or more embodiments, each described herein, component a is an anhydride-functionalized ethylene-based polymer, or an anhydride-functionalized propylene-based polymer. In one embodiment, or a combination of two or more embodiments, each described herein, component a is an anhydride-functionalized ethylene-based polymer, further an anhydride-functionalized ethylene/alpha-olefin interpolymer, and further an anhydride-functionalized ethylene/alpha-olefin copolymer.

In one embodiment, or a combination of two or more embodiments, each described herein, component a has a density ≥0.860 g/cc, or ≥0.862 g/cc, or ≥0.864 g/cc, or ≥0.866 g/cc, or ≥0.868 g/cc, or ≥0.870 g/cc, or ≥0.872 g/cc, or ≥0.874 g/, and/or ≤0.920 g/cc, or ≤0.915 g/cc, or ≤0.910 g/cc, or ≤0.905 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.879 g/cc.

In one embodiment, or a combination of two or more embodiments, each described herein, the first composition further comprises a tackifier (component c).

In one embodiment, or a combination of two or more embodiments, each described herein, the weight ratio of component a to component b is ≥2.0, or ≥4.0, or ≥6.0, or ≥8.0, and/or ≤40, or ≤38, or ≤36, or ≤34.

In one embodiment, or a combination of two or more embodiments, each described herein, the first composition comprises ≥80.0 wt %, or ≥85.0 wt %, or ≥90.0 wt %, or ≥92.0 wt %, or ≥94.0 wt %, or ≥96.0 wt %, or ≥98.0 wt %, or ≥99.0 wt %, or ≥99.2 wt %, or ≥99.4 wt % and/or ≤100.0 wt %, or ≤99.9 wt %, ≤99.8 wt %, or ≤99.7 wt %, or ≤99.6 wt % of the sum of components a, b and c, based on the weight of the first composition.

In one embodiment, or a combination of two or more embodiments, each described herein, the first composition comprises ≥50.0 wt %, or ≥55.0 wt %, or ≥60.0 wt %, or ≥62.0 wt %, or ≥64.0 wt %, or ≥66.0 wt %, or ≥68.0 wt %, or ≥70.0 wt %, and/or ≤100.0 wt %, or ≤95.0 wt %, or ≤90.0 wt %, or ≤85.0 wt %, or ≤80.0 wt %, or ≤78.0 wt %, or ≤76.0 wt %, or ≤74.0 wt % of the sum of components a and b, based on the weight of the first composition.

In one embodiment, or a combination of two or more embodiments, each described herein, the first composition has a percent increase in melt viscosity at 120 °C (% Δη4 at 120 °C)≤45%, or ≤40%, or ≤38%, or ≤36% and/or ≥10%, or ≥15%, or ≥18%; and where % Δη4 at 120 °C=[(η4−η1)/η1]×100, and where η4 is the melt viscosity after 4 hours at 120 °C, and η1 is the melt viscosity after 1 hour at 120 °C.

In one embodiment, or a combination of two or more embodiments, each described herein, the first composition, after 7 days at 22 °C, 50% RH, in air, has SAFT value≥80 °C, or ≥82 °C, or ≥84 °C, or ≥86 °C, or ≥88 °C, or ≥90 °C, or ≥93 °C, or ≥95 °C, and/or ≤200 °C.

In one embodiment, or a combination of two or more embodiments, each described herein, the first composition, after seven days at 35 °C, 85% RH, in air, has SAFT value≥100 °C, or ≥105 °C, or ≥115 °C, or ≥120 °C, or ≥130 °C, or ≥140 °C, or ≥150 °C, or ≥160 °C, or ≥170 °C, and/or ≤250 °C.

Also provided is a process to form a composition comprising a crosslinked olefin-based polymer formed from the first composition of one embodiment, or a combination of two or more embodiments, each described herein, said process comprising at least the following steps A) and B): A) mixing together at least the components a and b to form the first composition; B) exposing the first composition to moisture to form the crosslinked olefin-based polymer.

In one embodiment, or a combination of two or more embodiments, each described herein, step A takes place at a temperature≥120 °C, or ≥130 °C, or ≥140 °C, or ≥150 °C, or ≥160 °C, or ≥165 °C, or ≥170 °C, or ≥175 °C, or ≥180 °C, and/or ≤220 °C, or ≤215 °C, or ≤210 °C, or ≤205 °C, or ≤200 °C. In one embodiment, or a combination of two or more embodiments, each described herein, step A takes place at a relative humidity (% RH)≥10%, or ≥15%, or ≥20%, or ≥25%, or ≥30%, or ≥35%, and/or ≤60%, or ≤55%, or ≤50%, or ≤45%, or ≤40%.

In one embodiment, or a combination of two or more embodiments, each described herein, step B takes place at a temperature≥20 °C, or ≥21 °C, or ≥22 °C, or ≥24 °C, or ≥26 °C, or ≥28 °C, or ≥30 °C, or ≥32 °C, or ≥34 °C, and/or ≤100 °C, or ≤90 °C, or ≤80 °C, or ≤70 °C, or ≤60 °C, or ≤50 °C, or ≤45 °C, or ≤40 °C. In one embodiment, or a combination of two or more embodiments, each described herein, step B takes place at a percent relative humidity (% RH)≥40%, or ≥42%, or ≥44%, or ≥46%, or ≥48%, or ≥50%, and/or ≤100%, or ≤95%, or ≤90%, or ≤88%, or ≤86%, or ≤85%.

Also provided is crosslinked composition formed from the first composition of any one embodiment, or a combination of two or more embodiments, each described herein; or formed from the process of any one embodiment, or a combination of two or more embodiments, each described herein.

Also provided is an article comprising the first composition of any one embodiment, or a combination of two or more embodiments, each described herein. Also provided is an article comprising at least one component formed from the first composition of any one embodiment, or a combination of two or more embodiments, each described herein.

### Anhydride-Functionalized Olefin-Based Polymers

An “anhydride-functionalized olefin-based polymer” is a olefin-based polymer with anhydride moieties bonded to the olefin-based polymer chain (for example, an anhydride moiety grafted to an ethylene/α-olefin interpolymer chain, or to a propylene/ethylene interpolymer). Nonlimiting examples of suitable anhydrides include maleic anhydride (MAH), and itaconic anhydride, citraconic anhydride, tetrahydrophthalic anhydride, bromomaleic anhydride, chloromaleic anhydride, nadic anhydride, methylnadic anhydride, and alkenylsuccinic anhydride.

Olefin-based polymers include, for example, ethylene-based polymers and propylene-based polymers. Nonlimiting examples of suitable ethylene-based polymers include ethylene homopolymers, ethylene/alpha-olefin interpolymers and ethylene/alpha-olefin copolymers. Nonlimiting examples of suitable alpha-olefins include C3-C20 alpha-olefins, or C3-C10 alpha-olefins, or C3-C8 alpha-olefins. Representative alpha-olefins include propylene, 1-butene, 1-pentene, 1-hexene, 1-heptene and 1-octene. The distribution of the monomeric units, and in particular, the alpha-olefin, may be random, block, homogeneous, heterogeneous, and so on. Preferably, the interpolymer or copolymer is a random interpolymer or copolymer (that is, the polymer comprises a random distribution of its monomeric constituents).

Nonlimiting examples of suitable propylene-based polymers include propylene homopolymers, propylene/ethylene interpolymers and copolymers, and propylene/alpha-olefin interpolymers and copolymers. Nonlimiting examples of suitable alpha-olefins include C4-C20 alpha-olefins, or C4-C10 alpha-olefins, or C4-C8 alpha-olefins. Representative alpha-olefins include 1-butene, 1-pentene, 1-hexene, 1-heptene and 1-octene.

### Tackifiers

Tackifiers are known in the art, and may be solids, semi-solids, or liquids at room temperature. Preferred tackifiers include aliphatic, cycloaliphatic and aromatic hydrocarbons, modified hydrocarbons, and hydrogenated versions of such hydrocarbons.

### Waxes

Waxes include, but are not limited to, paraffin waxes; microcrystalline waxes; high density, low molecular weight polyethylene waxes or polypropylene waxes; thermally degraded waxes; by-product polyethylene waxes; and Fischer-Tropsch waxes. A wax may be present in an amount from ≥0 wt %, or ≥0.1 wt %, or ≥1.0 wt %, or ≥5.0 wt % and/or 40 wt %, or ≤30 wt %, or ≤20 wt %, based on the weight of the first composition.

Additives and Applications A first composition may comprise one or more additives. Additives include, but are not limited to, cure catalysts, fillers, pigments, UV stabilizers, anti-oxidants, processing aids, solvents, and further cure catalysts, UV stabilizers, and anti-oxidants. In one embodiment, an additive is present in an amount ≥0.01 wt %, or ≥0.02 wt %, or ≥0.05 wt %, or ≥0.10 wt %, or ≥0.20 wt % and/or ≤2.0 wt %, or ≤1.5 wt %, or ≤1.0 wt %, or ≤0.90 wt %, or ≤0.80 wt %, or ≤0.70 wt %, or ≤0.60 wt %, or ≤0.50 wt %, or ≤0.40 wt %, or ≤0.30 wt %, based on the weight of the first composition. A solvent may be present in an amount from 1.0 to 10 wt %, based on the weight of the first composition.

The first composition may comprise one or more polymer(s) different from the anhydride-functionalized olefin-based polymer (component a). For example, polar copolymers such as acrylates and vinyl acetates with ethylene, or polymer blends of a polar copolymer and a non-polar olefin-based polymer. In one embodiment, an additional polymer or polymer blend is present in an amount ≥0.5 wt %, or ≥1.0 wt %, or ≥2.0 wt %, or ≥3.0 wt %, or ≥4.0 wt % and/or ≤0 wt %, or ≤9.0 wt %, or ≤8.0 wt %, or ≤7.0 wt %, or ≤6.0 wt %, or ≤5.0 wt %, based on the weight of the first composition.

The components of the first composition may be mixed at high temperature in an extruder or in mixing vessels, as is typical for the hot melt adhesive industry. The order of addition of the components can be further optimized to ensure the most stable formulation results. For example, all of the components can be added in one mixing vessel, or if more appropriate, the anhydride-functionalized polymer and the epoxy-silane can be mixed separately first, and in a separate step, then mixed with the rest of the components.

The excellent stability and crosslinking features make the compositions well suited for adhesive applications. The compositions are suitable for those applications in which a long open time is required, such as woodworking or bookbinding applications. Many other applications will benefit from the delayed curing of the compositions.

### DEFINITIONS

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers (for example, antioxidants).

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a interpolymer that comprises, in polymerized form, 50 wt % or a majority weight percent of ethylene (based on the weight of the interpolymer), and an alpha-olefin.

The term “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types.

The term “propylene-based polymer,” as used herein, refers to a polymer that comprises, in polymerized form, a majority weight percent of propylene (based on the weight of the polymer), and optionally may comprise one or more comonomers.

The term “propylene/alpha-olefin interpolymer,” as used herein, refers to interpolymer that comprises, in polymerized form, a majority weight percent of propylene (based on the weight of the interpolymer), and an alpha-olefin. The term “propylene/alpha-olefin copolymer,” as used herein, refers to a copolymer that comprises, in polymerized form, a majority weight percent of propylene (based on the weight of the copolymer), and an alpha-olefin, as the only two monomer types.

The term “propylene/ethylene interpolymer,” as used herein, refers to a interpolymer that comprises, in polymerized form, a majority weight percent of propylene (based on the weight of the interpolymer), and ethylene. The term “propylene/ethylene copolymer,” as used herein, refers to a copolymer that comprises, in polymerized form, a majority weight percent of propylene (based on the weight of the copolymer), and ethylene, as the only two monomer types.

The term “anhydride-functionalized olefin-based polymer,” as used herein, refers to an olefin-based polymer that comprises anhydride groups bonded to the olefin-based polymer.

See prior discussion. Such anhydride groups may be derived from maleic anhydride or other anhydride compounds. The anhydride groups may be converted to carboxylic acid groups by reaction with water.

The phrase “a majority weight percent,” as used herein, in reference to a polymer (or interpolymer or copolymer), refers to the amount of monomer present in the greatest amount in the polymer.

The phrase “crosslinked olefin-based polymer,” as used herein, is understood by those skilled in the art, and refers to a polymer that has a network structure due to the formation of chemical bonds between polymer chains. The extent (or degree) of the network structure is determined by the SAFT failure temperature. The higher this temperature, the greater the extent of the network (or the greater the amount of crosslinks present in the crosslinked olefin-based polymer).

The phrase “crosslinked olefin-based polymer formed from the first composition,” or similar phrases, as used herein, refer to the crosslinking (or curing) of the “anhydride-functionalized polymer” with at least one polymer-based epoxy-silane, to form the “crosslinked polymer.”

The term “polymer-based epoxy silane,” as used herein, refers to a polymer or oligomer that comprises chemical repeating units and at least one epoxy group and at least one siloxane group (see claim 1). Optionally, a repeating unit (for example, designated “A”) may be separated from other like repeating units by one or more intervening repeating units of different chemical structure(s) (for example, designated “B”, “C” or “D”). For example, -A-B-A-B—B-A- or -A-B-A-C-D-A-A-A-.

The term “Percent Relative Humidity (% RH)” is the amount of water vapor present in air, and expressed as a percentage of the amount needed for saturation at the same temperature. The % RH can be measured using a humidity meter, such as a Hygrometer or humidity gage—each measuring the relative humidity in air.

The phrase “exposing the first composition to moisture,” as used herein, refers to contacting the first composition to an atmosphere that contains water, typically in the gaseous state. Such an exposure can occur, for example, in air or in an air oven set at a particular % RH.

The term “heteroatom,” refers to an atom other than hydrogen or carbon (for example, Si, O, N or P, and typically Si or O).

The term “heteroatom group” refers to a heteroatom or to a chemical group containing one or more heteroatoms.

The terms “hydrocarbon,” “hydrocarbyl group,” and similar terms, as used herein, refer to, respectively, a chemical compound or chemical group, etc., containing only carbon and hydrogen atoms.

The terms “heterohydrocarbon,” “heterohydrocarbyl group,” and similar terms, as used herein, refer to, respectively, a chemical compound or a chemical group, etc., containing carbon, hydrogen, in which one or more carbon atoms is/are independently replaced with a heteroatom group. (for example, Si, O, N or P).

The term “hydrocarbylene,” “hydrocarbylene group,” and similar terms used herein, refer to a divalent hydrocarbon, or a divalent hydrocarbon group, and such.

The term “heterohydrocarbylene,” “heterohydrocarbylene group,” and similar terms used herein, refer to a divalent hydrocarbylene or divalent hydrocarbylene group, etc., in which one or more carbon atoms is/are independently replaced with a heteroatom group.

The term “divalent linker group,” as used herein, refers to a divalent chemical group comprising at least two atoms.

The phrases “thermally treated,” “thermal treatment,” and similar phrases, as used herein, in reference to a first composition, refer to increasing the temperature of the composition by, for example, the application of heat and/or radiation. Note, the temperature at which the thermal treatment takes place, refers to the temperature of the composition (for example, the melt temperature of the composition).

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include, for example, any additional additive, adjuvant, or compound, whether polymeric or otherwise, unless stated to the contrary. In contrast, the term “consisting essentially of” excludes from the scope of any succeeding recitation any other component, step or procedure, excepting those that are not essential to operability. The term “consisting of” excludes any component, step or procedure, not specifically delineated or listed.

Listing of Some Composition and Process Features
A] A first composition comprising at least the following components a and b:
a) an anhydride functionalized olefin-based polymer;
b) a polymer-based epoxy silane comprising the following i) and ii):
   i) at least one epoxy group selected from the following ia) through ic):
ia)

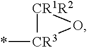

where R1, R2 and R3 are each independently H or an alkyl, and the asterisk (*) represents the remainder of the polymer-based epoxy silane,
ib)

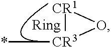

where R1 and R3 are each independently H or an alkyl, the term “Ring” represents a ring structure comprising ≥5 carbon atoms, and the asterisk (*) represents the remainder of the polymer-based epoxy silane, or ic) a combination of ia) and ib);
ii) at least one siloxane group selected from the following iia) through iic):
iia)

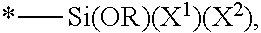

where X1 and X2 are each independently an alkyl group or an alkoxy group, R is an alkyl group, and the asterisk (*) represents the remainder of the polymer-based epoxy silane,
iib)

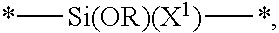

where X1 is an alkyl group or an alkoxy group, R is an alkyl group, and each asterisk (*) independently represents the respective remainder of the polymer-based epoxy silane; or iic) a combination of iia) and iib); and
wherein the polymer-based epoxy silane comprises ≥2 silicon atoms.
B] The first composition of A] above, wherein, for structure ib), the ring structure comprises ≥6 carbon atoms, and further 6 carbon atoms.
C] The first composition of A] or B] above, wherein, for structure ib), the ring structure comprises ≤10, or ≤9, or ≤8, or ≤7 carbon atoms.
D] The first composition of any one of A]-C](A] through C]) above, wherein, the polymer-based epoxy silane comprises ≥3, or ≥4, or ≥5, or ≥6, or ≥8, or ≥10 Si atoms.
E] The first composition of any one of A]-D] above, wherein the polymer-based epoxy silane further comprises one or more of the following chemical groups a) through i):
a) —(CR¹R²—CR³R⁴)—, where each of R1, R2, R3, R4 is independently H or an alkyl, and further each of R1, R2, R3, R4 is the same, and further R1=R2=R3-R4=H; b) —(SiR1R2-O)—, where each of R1, R2 is independently an alkyl, and further R1=R2, and further R1=R2=a C1-C5 alkyl group, further a C₁-C₄ alkyl group, further a C₁-C₃ alkyl group, further a C1-C2 alkyl group, further a methyl group; c) —(Si(R)(CR¹=CR²R³))—, where R is an alkyl and further a C1-C5 alkyl group, further a C1-C4 alkyl group, further a C1-C3 alkyl group, further a C1-C2 alkyl group, further a methyl group, and each of R1, R2, R3 is independently H or an alkyl, and further each of R1, R2, R3 is the same, and further R1=R2=R3=H; d) —(CR¹R²—CR³(CR⁴=CR⁵R⁶))—, where each of R1, R2, R3, R4, R5, R6 is independently H or an alkyl, and further each of R1, R2, R3, R4, R5, R6 is the same, and further R1=R2=R3=R4=R5=R6=H; e) amide; f) ester; g) urethane; h) —(CR1R2-CR3R4)-, where each of R1, R2, R3 is independently H or an alkyl, and further each of R1, R2, R3 is the same, and further R1=R2=R3=H, and R4 is an aryl group, and further R4 is a phenyl group; or i) any combination thereof, and
   wherein each chemical group is derived from one or more monomers; and when present, each chemical group is present in at least two repeating units within the polymer-based epoxy silane.
F] The first composition of any one of A]-E] above, wherein the polymer-based epoxy silane further comprises one or more of the following chemical groups a) through d) or i).
a) —(CR¹R²—CR³R⁴)—, where each of R1, R2, R3, R4 is independently H or an alkyl, and further each of R1, R2, R3, R4 is the same, and further R1=R2=R3-R4=H; b) —(SiR¹R²—O)—, where each of R¹, R² is independently an alkyl, and further R¹=R², and further R1=R2=a C1-C5 alkyl group, further a C1-C4 alkyl group, further a C1-C3 alkyl group, further a C1-C2 alkyl group, further a methyl group; c) —(Si(R)(CR¹=CR²R³))—, where R is an alkyl and further a C1-C5 alkyl group, further a C1-C4 alkyl group, further a C1-C3 alkyl group, further a C1-C2 alkyl group, further a methyl group, and each of R¹, R², R³ is independently H or an alkyl, and further each of R1, R2, R3 is the same, and further R1=R2=R3=H; d) —(CR¹R²—CR³(CR⁴=CR⁵R⁶))—, where each of R1, R2, R3, R4, R5, R6 is independently H or an alkyl, and further each of R1, R2, R3, R4, R5, R6 is the same, and further R1=R2=R3=R4=R5=R6=H; or i) any combination thereof, and
   wherein each chemical group is derived from one or more monomers; and when present, each chemical group is present in at least two repeating units within the polymer-based epoxy silane.
G] The first composition of any one of A]-F] above, wherein, for structure iia), R is a C1-C5 alkyl group, further a C1-C4 alkyl group, further a C1-C3 alkyl group, further a C1-C2 alkyl group, further a methyl group.
H] The first composition of any one of A]-G] above, wherein, for structure iia), the X1 and X2 are each independently an alkoxy group, and further X1=X2, and further X1=X2=OR, and further R is a C1-C5 alkyl group, further a C1-C4 alkyl group, further a C1-C3 alkyl group, further a C1-C2 alkyl group, further a methyl group.
I] The first composition of any one of A]-H] above, wherein, for structure iib), R is a C1-C5 alkyl group, further a C1-C4 alkyl group, further a C1-C3 alkyl group, further a C1-C2 alkyl group, further a methyl group.
J] The first composition of any one of A]-I] above, wherein, for structure iib), the X1 is an alkoxy group, and further X1=OR, and further R is a C1-C5 alkyl group, further a C1-C4 alkyl group, further a C1-C3 alkyl group, further a C1-C2 alkyl group, further a methyl group.
K] The first composition of any one of A]-J] above, wherein, for structure ia), the R¹, R² and R³ are each H.
L] The first composition of any one of A]-K] above, wherein, for structure ib), the R1 and R3 are each H.
M] The first composition of any one of A]-L] above, wherein the polymer-based epoxy silane comprises at least one of the following structures T1a through T1c:
T1a)

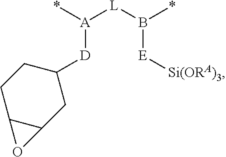

where D is a hydrocarbylene or a heterohydrocarbylene; E is a hydrocarbylene or a heterohydrocarbylene; A is —(CR1R2-CR3)- or —(O—SiR4)-, where R1, R2, R3 are each independently H or an alkyl, and R4 is an alkyl; B is —(CR5R6-CR7)- or —(O—SiR8)-, where R5, R6, R7 are each independently H or an alkyl, and R8 is an alkyl; and wherein at least one of D, E, A or B comprises at least one Si atom; RA is an alkyl, L is a divalent linker group, and each asterisk (*) independently represents the respective remainder of the polymer-based epoxy silane;
T1b)

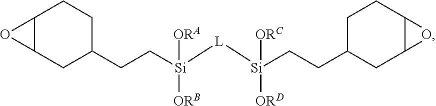

where RA, RB, RC and RD are each independently an alkyl, and L is a divalent linker group; T1c) a combination of T1a and T1b.
N] The first composition of M] above, wherein the T1a structure (as shown) has an molecular weight ≥500 g/mole, or ≥600 g/mole, or ≥700 g/mole, or ≥800 g/mole, or ≥900 g/mole, or ≥1000 g/mole, and/or ≤50,000 g/mole, or ≤40,000 g/mole, or ≤30,000 g/mole, or ≤20,000 g/mole, or ≤10,000 g/mole, or ≤9,000 g/mole, or ≤8,000 g/mole, or ≤7,000 g/mole, or ≤6,000 g/mole, or ≤5,000 g/mole.
O] The first composition of M] or N] above, wherein, for the T1a structure, component A, R1=R2=R3, and further R1=R2=R3=H.
P] The first composition of any one of M]-O] above, wherein, for the T1a structure, component A, R4 is a C1-C5 alkyl group, further a C1-C4 alkyl group, further a C1-C3 alkyl group, further a C1-C2 alkyl group, further a methyl group.
Q] The first composition of any one of M]-P] above, wherein, for the T1a structure, component B, R5=R6=R7, and further R5=R6=R7=H.
R] The first composition of any one of M]-Q] above, wherein, for the T1a structure, component B, R8 is a C1-C5 alkyl group, further a C1-C4 alkyl group, further a C1-C3 alkyl group, further a C1-C2 alkyl group, further a methyl group.
S] The first composition of any one of M]-R] above, wherein, for the T1a structure, component D comprises at least one of the following groups: —CH₂—, —Si(R)₂—, —Si(R)₂—O—, or any combination thereof, and further each R is independently a C1-C5 alkyl group, further a C1-C4 alkyl group, further a C1-C3 alkyl group, further a C1-C2 alkyl group, further a methyl group.
T] The first composition of any one of M]-S] above, wherein, for the T1a structure, component E comprises at least one of the following groups: —CH₂—, —Si(R)₂—, or any combination thereof, and further R is independently a C1-C5 alkyl group, further a C1-C4 alkyl group, further a C1-C3 alkyl group, further a C1-C2 alkyl group, further a methyl group.
U] The first composition of any one of M]-T] above, wherein, for the T1a structure, L comprises ≥4 atoms, or ≥6 atoms.
V] The first composition of any one of M]-U] above, wherein, for the T1a structure, L comprises C, Si, or a combination thereof. Further L comprises one or more of the following units: —(CH₂—CHR)—, where R is H, alkyl or alkenyl; —(OSi(R)₂)—, where R is alkyl; —(SiRR′)—, where R is alkyl and R′ is alkyl or alkenyl; or any combination thereof.
W] The first composition of any one of M]-V] above, wherein the T1b structure has an molecular weight ≥500 g/mole, or ≥600 g/mole, or ≥700 g/mole, or ≥800 g/mole, or ≥900 g/mole, or ≥1000 g/mole, and/or ≤50,000 g/mole, or ≤40,000 g/mole, or ≤30,000 g/mole, or ≤20,000 g/mole, or ≤10,000 g/mole, or ≤9,000 g/mole, or ≤8,000 g/mole, or ≤7,000 g/mole, or ≤6,000 g/mole, or ≤5,000 g/mole.
X] The first composition of any one of M]-W] above, wherein, for the T1b structure, RA is a C1-C5 alkyl group, further a C1-C4 alkyl group, further a C1-C3 alkyl group, further a C1-C2 alkyl group, further a methyl group.
Y] The first composition of any one of M]-X] above, wherein, for the T1b structure, RB is a C1-C5 alkyl group, further a C1-C4 alkyl group, further a C1-C3 alkyl group, further a C1-C2 alkyl group, further a methyl group.
Z] The first composition of any one of M]-Y] above, wherein, for the T1b structure, RC is a C1-C5 alkyl group, further a C1-C4 alkyl group, further a C1-C3 alkyl group, further a C1-C2 alkyl group, further a methyl group.
A2] The first composition of any one of M]-Z] above, wherein, for the T1b structure, RD is a C1-C5 alkyl group, further a C1-C4 alkyl group, further a C1-C3 alkyl group, further a C1-C2 alkyl group, further a methyl group.
B2] The first composition of any one of M]-A2] above, wherein, for the T1b structure, RA=RB=RC=RD, and further each is a C1-C5 alkyl group, further a C1-C4 alkyl group, further a C1-C3 alkyl group, further a C1-C2 alkyl group, further a methyl group.
C2] The first composition of any one of M]-B2] above, wherein, for the T1b structure, L comprises ≥4 atoms, or ≥6 atoms.
D2] The first composition of any one of M]-C2] above, wherein, for the T1b structure, L comprises C, Si, or a combination thereof. Further L comprises one or more of the following units: —(CH₂—CHR)—, where R is H, alkyl or alkenyl; —(OSi(R)₂)—, where R is alkyl; —(SiRR′)—, where R is alkyl and R′ is alkyl or alkenyl; or any combination thereof.
E2] The first composition of any one of M]-D2] above, wherein the polymer-based epoxy silane comprises structure T1a.
F2] The first composition of any one of M]-E2] above, wherein for structure T1a, A is —(CR1R²—CR3)-, where R1, R2, R3 are each independently H or an alkyl; and B is —(CR5R6-CR7)-, where R5, R6, R7 are each independently H or an alkyl.
G2] The first composition of any one of M]-E2] above, wherein for structure T1a, A is —(O—SiR4)-, where R4 is an alkyl; and B is —(O—SiR8)-, where R8 is an alkyl.
H2] The first composition of any one of A]-E2] above, wherein the polymer-based epoxy silane comprises one of the following structures T3a1, T3a2, T3a3, T3a4, T3a5 or T3a6:

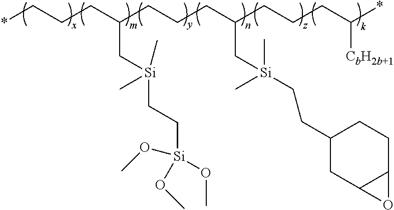

T3a1), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane;

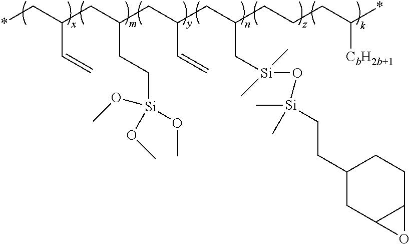

T3a2), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane;

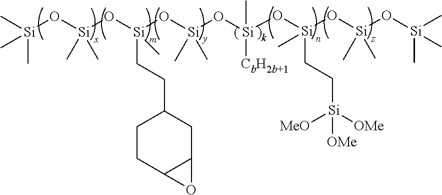

T3a3), where b is a number from 1 to 20, m is a number from 1 to 10, n is a number from 1 to 10, each of x, y, z and k is independently a number from 1 to 300;

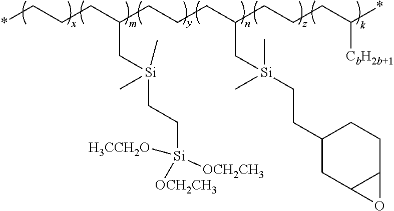

T3a4), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane;

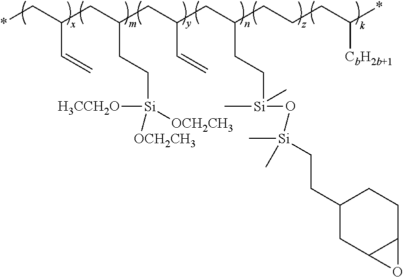

T3a5), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane;

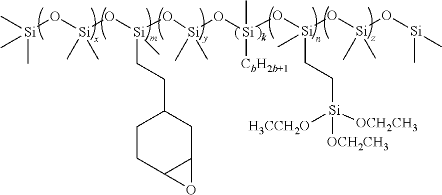

T3a6), where b is a number from 1 to 20, m is a number from 1 to 10, n is a number from 1 to 10, each of x, y, z and k is independently a number from 1 to 300.
I2] The first composition of any one of M]-D2] above, wherein the polymer-based epoxy silane comprises structure T1b.
J2] The first composition of any one of M]-D2] or H2] above, wherein the polymer-based epoxy silane comprises structures T1a and T1b.
K2] The first composition of any one of A]-J2] above, wherein the polymer-based epoxy silane has a viscosity (25 °C)≤1000 mPa·s, or ≤800 mPa·s, or ≤600 mPa·s, and/or ≥50 mPa·s, or ≥100 mPa·s, or ≥150 mPa·s, or ≥200 mPa·s.
L2] The first composition of any one of A]-K2] above, wherein the molar ratio of epoxy groups on the polymer-based epoxy-silane to anhydride groups on the “anhydride-functionalized olefin-based polymer” is ≥0.10, or ≥0.15, or ≥0.20, or ≥0.25, or ≥0.30, or ≥0.35, or ≥0.40, or ≥0.45, or ≥0.50, or ≥0.52, and/or ≤2.00, or ≤1.80, or ≤1.60, or ≤1.40, or ≤1.20, or ≤1.15, or ≤1.10.
M2] The first composition of any one of A]-L2] above, wherein component a is an anhydride-functionalized ethylene-based polymer, or an anhydride-functionalized propylene-based polymer.
N2] The first composition of any one of A]-M2] above, wherein component a is an anhydride-functionalized ethylene-based polymer, further an anhydride-functionalized ethylene/alpha-olefin interpolymer, and further an anhydride-functionalized ethylene/alpha-olefin copolymer.
O2] The first composition of any one of A]-N2] above, wherein component a is an anhydride-grafted ethylene-based polymer, further an anhydride-grafted ethylene/alpha-olefin interpolymer, and further an anhydride-grafted ethylene/alpha-olefin copolymer.
P2] The first composition of N2] or 02] above, wherein alpha-olefin is a C3-C20 alpha-olefin, and further a C3-C10 alpha-olefin, and further selected from propylene, 1-butene, 1-pentene, 1-hexene or 1-octene, and further propylene, 1-butene, 1-hexene or 1-octene, and further propylene, 1-butene or 1-octene, further 1-butene or 1-octene, and further 1-octene.
Q2] The first composition of any one of A]-M2] above, wherein component a is an anhydride-functionalized propylene-based polymer, further an anhydride-functionalized propylene/ethylene interpolymer or an anhydride-functionalized propylene/alpha-olefin interpolymer, and further an anhydride-functionalized propylene/ethylene copolymer or an anhydride-functionalized propylene/alpha-olefin copolymer.
R2] The first composition of any one of A]-M2] or Q2] above, wherein component a is an anhydride-grafted propylene-based polymer, further an anhydride-grafted propylene/ethylene interpolymer or an anhydride-grafted propylene/alpha-olefin interpolymer, and further an anhydride-grafted propylene/ethylene copolymer or an anhydride-grafted propylene/alpha-olefin copolymer.
S2] The first composition of Q2] or R2] above, wherein alpha-olefin is a C4-C20 alpha-olefin, and further a C4-C10 alpha-olefin, and further selected from 1-butene, 1-pentene, 1-hexene or 1-octene, and further 1-butene, 1-hexene or 1-octene, and further 1-butene or 1-octene, and further 1-octene.
T2] The first composition of any one of A]-S2] above, wherein component a has a density ≥0.860 g/cc, or ≥0.862 g/cc, or ≥0.864 g/cc, or ≥0.866 g/cc, or ≥0.868 g/cc, or ≥0.870 g/cc, or ≥0.872 g/cc, or ≥0.874 g/, and/or 0.920 g/cc, or ≤0.915 g/cc, or ≤0.910 g/cc, or ≤0.905 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.879 g/cc (1 cc=1 cm³).
U2] The first composition of any one of A]-T2] above, wherein component a has a melt viscosity (177 °C) 100,000 mPa·s, or ≤80,000 mPa·s, or ≤60,000 mPa·s, or ≤50,000 mPa·s, or ≤40,000 mPa·s, or ≤30,000 mPa·s, or ≤25,000 mPa·s, or ≤20,000 mPa·s, or ≤18,000 mPa·s, or ≤16,000 mPa·s, or ≤14,000 mPa·s, and/or ≥1,000 mPa·s, or ≥2,000 mPa·s, or ≥4,000 mPa·s, or ≥6,000 mPa·s, or ≥8,000 mPa·s, or ≥10,000 mPa·s.
V2] The first composition of any one of A]-U2] above, wherein component a has a melt index (I2)≥200, or ≥300, or ≥400, or ≥500, or ≥550 dg/min, and/or 2,000, or ≤1,500, or ≤1,000, or ≤900, or ≤800, or ≤700 dg/min.
W2] The first composition of any one of A]-V2] above, wherein component a has a melting point (Tm)≥50 °C, or ≥55 °C, or ≥60 °C, or ≥65 °C, and/or ≤120 °C, or ≤110 °C, or ≤100 °C, or ≤90 °C, or ≤80 °C, or 75 °C, or ≤70 °C.
X2] The first composition of any one of A]-W2] above, wherein component a has a glass transition temperature (Tg)≥−70 °C, or ≥−68 °C, or ≥−66 °C, or ≥−64 °C, or ≥−62 °C, or ≥−60 °C, and/or ≤−40 °C, or ≤−45 °C, or ≤−48 °C, or ≤−50 °C, or ≤−52 °C, or ≤−55 °C.
Y2] The first composition of any one of A]-X2] above, wherein component a has a percent crystallinity ≥10%, or ≥12%, or ≥14%, or ≥16%, or ≥18%, and/or 40%, or ≤35%, or ≤30%, or ≤28%, or ≤26%, or ≤24%, or ≤22%.
Z2] The first composition of any one of A]-Y2] above, wherein component a has a weight average molecular weight Mw ≥10,000 g/mol, or ≥20,000 g/mol, or ≥30,000 g/mol, or ≥32,000 g/mol, or ≥34,000 g/mol, or ≥35,000 g/mol, and/or ≤60,000 g/mol, or ≤50,000 g/mol, or ≤48,000 g/mol, or ≤45,000 g/mol, or ≤42,000 g/mol, or ≤40,000 g/mol.
A3] The first composition of any one of A]-Z2] above, wherein component a has a number average molecular weight Mn ≥6,000 g/mol, or ≥8,000 g/mol, or ≥10,000 g/mol, or ≥12,000 g/mol, and/or ≤50,000 g/mol, or ≤40,000 g/mol, or ≤30,000 g/mol, or ≤28,000 g/mol, or K 26,000 g/mol, or ≤24,000 g/mol, or ≤22,000 g/mol, or ≤20,000 g/mol.
B3] The first composition of any one of A]-A3] above, wherein component a has a molecular weight distribution (Mw/Mn)≥2.00, or ≥2.10, or ≥2.20, or ≥2.30, or ≥2.40, and/or ≤3.50, or ≤3.40, or ≤3.30, or ≤3.20, or ≤3.10, or ≤3.00, or ≤2.90, or ≤2.80, or ≤2.70, or ≤2.60, or 2.50.
C3] The first composition of any one of A]-B3] above, wherein component a comprises ≥0.1 wt %, or ≥0.2 wt %, or ≥0.4 wt %, or ≥0.6 wt %, or ≥0.8 wt %, or ≥1.0 wt %, or ≥1.1 wt %, and/or ≤20 wt %, or ≤15 wt %, or ≤10 wt %, or ≤5.0 wt %, or ≤4.0 wt %, or ≤3.5 wt %, or ≤3.0 wt %, or ≤2.5 wt %, or 2.0 wt %, or ≤1.8 wt %, or ≤1.6 wt % or 1.4 wt % of anhydride groups, based on the weight of component a.
D3] The first composition of any one of A]-C3] above, wherein the anhydride of the anhydride-functionalized olefin-based polymer is derived from maleic anhydride.
E3] The first composition of any one of A]-D3] above, wherein the first composition further comprises a tackifier (component c).
F3] The first composition of E3] above, wherein component c has a number average molecular weight Mn ≥50 g/mol, or ≥70 g/mol, or ≥100 g/mol, or ≥200 g/mol, and/or ≤1,000 g/mol, or ≤800 g/mol, or ≤600 g/mol, or ≤500 g/mol.
G3] The first composition of E3] or F3] above, wherein component c has a molecular weight distribution (Mw/Mn)≥1.2, or ≥1.4, or ≥1.6, and/or ≤2.2, or ≤2.0, or ≤1.8.
H3] The first composition of any one of E3]-G3] above, wherein component c is selected from a hydrocarbon resin, a silane modified hydrocarbon resin, or a combination thereof.
I3] The first composition of any one of E3]—H3] above, wherein component c is a hydrocarbon resin, further a hydrogenated hydrocarbon resin.
J3] The first composition of any one of E3]—H3] above, wherein component c is a silane modified hydrocarbon resin.
K3] The first composition of any one of E3]-J3] above, wherein the weight ratio of component a to component c is ≥1.00, or ≥1.20, or ≥1.40, or ≥1.60, or ≥1.80, or ≥2.00, or ≥2.10, or ≥2.20, and/or ≤3.00, or ≤2.80, or ≤2.60, or ≤2.50, or ≤2.40.
L3] The first composition of any one of A]-K3] above, wherein the weight ratio of component a to component b is ≥2.0, or ≥4.0, or ≥6.0, or ≥8.0, and/or 40, or ≤38, or ≤36, or ≤34.
M3] The first composition of any one of A]-L3] above, wherein the first composition comprises ≥15 wt %, or ≥20 wt %, or ≥30 wt %, or ≥40 wt %, or ≥50 wt %, or ≥55 wt %, or ≥60 wt %, or ≥62 wt %, and/or ≤99 wt %, or ≤95 wt %, or ≤90 wt %, or ≤85 wt %, or ≤80 wt %, or ≤75 wt %, or ≤70 wt % of the component a, based on the weight of the first composition.
N3] The first composition of any one of A]-M3] above, wherein the first composition comprises ≥0.50 wt %, or ≥1.0 wt %, or ≥1.5 wt %, or ≥2.0 wt %, and/or 20 wt %, or ≤15 wt %, or ≤12 wt %, or ≤10 wt %, or ≤8.0 wt % of the component b, based on the weight of the first composition.
O3] The first composition of any one of A3]—N3] above, wherein the first composition comprises ≥5.0 wt %, or ≥10 wt %, or ≥15 wt %, or ≥20 wt %, or ≥22 wt %, or ≥24 wt %, or ≥26 wt %, and/or ≤50 wt %, or ≤45 wt %, or ≤40 wt %, or ≤38 wt %, or ≤36 wt %, or ≤34 wt %, or ≤32 wt %, or ≤30 wt % of the component c, based on the weight of the first composition.
P3] The first composition of any one of E3]-03] above, wherein the first composition comprises ≥80.0 wt %, or ≥85.0 wt %, or ≥90.0 wt %, or ≥92.0 wt %, or ≥94.0 wt %, or ≥96.0 wt %, or ≥98.0 wt %, or ≥99.0 wt %, or ≥99.2 wt %, or ≥99.4 wt % and/or ≤100.0 wt %, or ≤99.9 wt %, ≤99.8 wt %, or ≤99.7 wt %, or ≤99.6 wt % of the sum of components a, b and c, based on the weight of the first composition.
Q3] The first composition of any one of A]-P3] above, wherein the first composition comprises ≥50.0 wt %, or ≥55.0 wt %, or ≥60.0 wt %, or ≥62.0 wt %, or ≥64.0 wt %, or ≥66.0 wt %, or ≥68.0 wt %, or ≥70.0 wt %, and/or ≤100.0 wt %, or ≤95.0 wt %, or ≤90.0 wt %, or ≤85.0 wt %, or ≤80.0 wt %, or ≤78.0 wt %, or ≤76.0 wt %, or ≤74.0 wt % of the sum of components a and b, based on the weight of the first composition.
R³] The first composition of any one of A]-Q3] above, wherein the first composition has a melt viscosity (I1), after 1 hour at 120 °C, ≥5,000, or ≥10,000, or ≥15,000, or ≥20,000, or ≥25,000, or ≥30,000, or ≥32,000, or ≥34,000 mPa·s, or ≥36,000 mPa·s, and/or 80,000, or ≤75,000, or ≤70,000, or ≤68,000, or ≤66,000, or ≤64,000 mPa·s.
S3] The first composition of any one of A]-R³] above, wherein the first composition has a percent increase in melt viscosity at 120 °C (% Δη2 at 120 °C)≤35%, or ≤30%, or ≤28%, or ≤26%, or ≤24%, or ≤22%, or ≤20%, and/or ≥1.0%, or ≥2.0%, or ≥3.0%, or 4.0%; and where % Δη2 at 120 °C=[(η2 −η1)/η1]×100, and where η2 is the melt viscosity after 2 hours at 120 °C, and al is the melt viscosity after 1 hour at 120 °C.
T3] The first composition of any one of A]-S3] above, wherein the first composition has a percent increase in melt viscosity at 120 °C (% Δη3 at 120 °C)≤35%, or ≤30%, or ≤28%, or ≤26%, or ≤24%, and/or ≥1.0%, or ≥5.0%, or ≥8.0%, or 10%; or 12%; and where % Δη3 at 120 °C=[(η3 −η₁)/η1]×100, and where η3 is the melt viscosity after 3 hours at 120 °C, and η1 is the melt viscosity after 1 hour at 120 °C.
U3] The first composition of any one of A]-T3] above, wherein the first composition has a percent increase in melt viscosity at 120 °C (% Δη4 at 120 °C)≤45%, or ≤40%, or ≤38%, or ≤36% and/or ≥10%, or ≥15%, or ≥18%; and where % Δη4 at 120 °C=[(η4−η1)/η1]×100, and where η4 is the melt viscosity after 4 hours at 120 °C, and η1 is the melt viscosity after 1 hour at 120 °C.
V3] The first composition of any one of A]-U3] above, wherein the first composition, after 7 days at 22 °C, 50% RH, in air atmosphere, has SAFT value≥80 °C, or ≥82 °C, or ≥84 °C, or ≥86 °C, or ≥88 °C, or ≥90 °C, or ≥93 °C, or ≥95 °C, and/or ≤200 °C.
W3] The first composition of any one of A]-V3] above, wherein the first composition, after 16 days at 22 °C, 50% RH, in air atmosphere, has SAFT value≥90 °C, or ≥92 °C, or ≥94 °C, or ≥96 °C, or ≥98 °C, or ≥100 °C, or ≥105 °C, or ≥110 °C, and/or ≤200 °C.
X3] The first composition of any one of A]-W3] above, wherein the first composition, after 21 days at 22 °C, 50% RH, in air atmosphere, has SAFT value≥150 °C, or ≥155 °C, or ≥160 °C, or ≥165 °C, or ≥170 °C, and/or ≤250 °C.
Y3] The first composition of any one of A]-X3] above, wherein the first composition, after seven days at 35 °C, 85% RH, in air, has SAFT value≥100 °C, or ≥110 °C, or ≥115 °C, or ≥120 °C, or ≥130 °C, or ≥140 °C, or ≥150 °C, or ≥160 °C, or ≥170 °C, and/or ≤250 °C.
Z3] The first composition of any one of A]-Y3] above, wherein the first composition further comprises at least one additive, and further at least one antioxidant.
A4] The first composition of any one of A]-Z3] above, wherein the first composition further comprises a polymer, different from component a in one or more features, such as monomer(s) types, monomer distributions, melt viscosity (177 °C), density, or any combination thereof.
B4] The first composition of any one of A]-A4] above, wherein the first composition comprises ≤0.50 ppm, or ≤0.20 ppm, or ≤0.10 ppm, or ≤0.05 ppm, or ≤0.02 ppm, or ≤0.01 ppm of a peroxide, and further the first composition does not comprise a peroxide.
A5] A process to form a composition comprising a crosslinked olefin-based polymer formed from the first composition of any one of A]-B4] above, said process comprising at least the following steps A) and B):
A) mixing together at least the components a and b to form the first composition;
B) exposing the first composition to moisture to form the crosslinked olefin-based polymer.
B5] The process of A5] above, wherein step A takes place at a temperature≥120 °C, or ≥130 °C, or ≥140 °C, or ≥150 °C, or ≥160 °C, or ≥165 °C, or ≥170 °C, or ≥175 °C, or ≥180 °C, and/or ≤220 °C, or ≤215 °C, or ≤210 °C, or ≤205 °C, or ≤200 °C.
C5] The process of A5] or B5] above, wherein step A takes place at a relative humidity (% RH)≥10%, or ≥15%, or ≥20%, or ≥25%, or ≥30%, or ≥35%, and/or ≤60%, or ≤55%, or ≤50%, or ≤45%, or ≤40%.
D5] The process of any one of A5]—C5] above, wherein step B takes place at a temperature≥20 °C, or ≥21 °C, or ≥22 °C, or ≥24 °C, or ≥26 °C, or ≥28 °C, or ≥30 °C, or ≥32 °C, or ≥34 °C, and/or ≤100 °C, or ≤90 °C, or ≤80 °C, or ≤70 °C, or ≤60 °C, or ≤50 °C, or ≤45 °C, or ≤40 °C.
E5] The process of any one of A5]-D5] above, wherein step B takes place at a temperature≥20 °C, or ≥30 °C, or ≥40 °C, or ≥50 °C, or ≥60 °C, or ≥70 °C, or ≥80 °C, and/or ≤150 °C, or ≤140 °C, or 130 °C, or ≤120 °C, or ≤100 °C.
F5] The process of any one of A5]-E5] above, wherein step B takes place at a percent relative humidity (% RH)≥40%, or ≥42%, or ≥44%, or ≥46%, or ≥48%, or ≥50%, and/or ≤100%, or ≤95%, or ≤90%, or ≤88%, or ≤86%, or ≤85%.
G5] The process of any one of A5]—F5] above, wherein composition comprises either a crosslinked ethylene-based polymer derived from an anhydride-functionalized ethylene-based polymer, or a crosslinked propylene-based polymer derived from an anhydride-functionalized propylene-based polymer.
H5] The process of any one of A5]-G5] above, wherein composition comprises a crosslinked ethylene-based polymer derived from an anhydride-functionalized ethylene-based polymer.
I5] A crosslinked composition formed from the process of any one of A5]—H5] above.
A6] A crosslinked composition formed from the first composition of any one of A]-B4] above.
B6] The first composition of any one of A]-B4] above, wherein the first composition is an adhesive, and further a hot melt adhesive.
C6] An article comprising the first composition of any one of A]-B4].
D6] An article comprising at least one component formed from the first composition of any one of A]-B4].
E6] An article comprising the crosslinked composition of I5] or A6].
F6] An article comprising at least one component formed from the crosslinked composition of I5] or A6].
G6] The article of any one of C6]—F6] above, wherein the composition adheres together two surfaces of the article.
H6] The article of any one of C6]—F6] above, wherein the article is furniture, a book or a container.

### Test Methods

### Melt Viscosity of Polymer and First Composition

Melt viscosity was measured in accordance with ASTM D 3236, using a Brookfield Viscometer (Model DV0III, version 3), and a SC-31 hot-melt viscometer spindle, at the following temperatures: a) 177 °C for the anhydride functionalized olefin-based polymer (component a); and b) 120 °C for the first composition. This method can also be used to measure the viscosity of a tackifier (at 160 °C), or the viscosity of a polymer-based epoxy silane (at 25 °C). The sample was poured into an aluminum disposable tube-shaped chamber, which was, in turn, inserted into a Brookfield Thermosel, and locked into place. The sample chamber had a notch on the bottom that fit the bottom of the Brookfield Thermosel, to ensure that the chamber was not allowed to turn, when the spindle was inserted and spinning. The sample (approximately 8-10 grams) was heated to the required temperature, until the melted sample was one inch below the top of the sample chamber. The viscometer apparatus was lowered, and the spindle was submerged into the middle of the sample chamber, wherein the spindle did not touch the sides of the chamber. Lowering was continued, until the brackets on the viscometer aligned on the Thermosel. The viscometer was turned on, and set to operate at a steady shear rate, which led to a torque reading in the range of 40 to 60 percent of the total torque capacity, based on the rpm output of the viscometer. Readings were taken every minute, for 15 minutes, or until the values stabilized, at which point, a final reading was recorded.

### Differential Scanning Calorimetry (DSC)

Differential Scanning Calorimetry (DSC), as discussed below, is used to measure Tm, Tc, Tg and crystallinity in ethylene-based (PE) samples and propylene-based (PP) samples, unless noted otherwise. Each sample (0.5 g) is compression molded into a film, at 25000 psi, 190 °C, for 10-15 seconds. About 5 to 8 mg of film sample is weighed and placed in a DSC pan. The lid is crimped on the pan to ensure a closed atmosphere. The sample pan is placed in a DSC cell, and then heated, at a rate of approximately 10 °C/min, to a temperature of 180 °C for PE (230 °C for PP). The sample is kept at this temperature for three minutes. Then the sample is cooled at a rate of 10 °C/min to −90 °C for PE (−60 °C for PP), and kept isothermally at that temperature for three minutes. The sample is next heated at a rate of 10 °C/min, until complete melting (second heat). Unless otherwise stated, melting point (Tm) and the glass transition temperature (Tg) of each polymer sample are determined from the second heat curve, and the crystallization temperature (Tc) is determined from the first cooling curve. The Tg and the respective peak temperature for the Tm are noted. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### Density

The density of a polymer is measured by preparing the polymer sample according to ASTM D 1928, and then measuring the density according to ASTM D792, Method B, within one hour of sample pressing.

### Gel Permeation Chromatography—Ethylene-Based Polymers

The chromatographic system consists of a PolymerChar GPC-IR (Valencia, Spain) high temperature GPC chromatograph, equipped with an internal infra-red detector (IR5). The autosampler oven compartment is set at 160 °C, and the column compartment is set at 150 °C. The columns are four AGILENT “Mixed A” 30 cm, 20-micron linear mixed-bed columns. The chromatographic solvent is 1,2,4-trichlorobenzene, which contains 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000 g/mol, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80 °C, with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)): M_{polyethylene}=A×(M_{polystyrene})^{B} (EQ1), where M is the molecular weight, A has a value of 0.4315 and B is equal to 1.0.

A fifth order polynomial is used to fit the respective polyethylene-equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation.) The plate count (Equation 2) and symmetry (Equation 3) are measured on a 200 microliter injection according to the following equations:

$$Plate Count = 5.54 * {( \frac{( {RV}_{Peak Max}}{Peak Width at \frac{1}{2} height} )}^{2}$$

(EQ2), where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{( R {V}_{Peak max} - Front Peak {RV}_{one tenth height} )}$$

(EQ3), where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contains 200 ppm BHT) is added to a pre nitrogen-sparged, septa-capped vial, via the PolymerChar high temperature autosampler. The samples are dissolved for two hours at 160 °C under “low speed” shaking.

The calculations of Mn(GPC), Mw(GPC), and Mz(GPC) are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} \frac{{\sum }^{i} ( {IR}_{i} ⋆ {M}_{{polyethylene}_{i}} )}{{\sum }^{i} {IR}_{i}} , \qquad ( EQ 5 )$$

$$and$$

$${Mz}_{( GPC )} \frac{{\sum }^{i} ( {IR}_{i} ⋆ {M}_{{polyethylene}_{i}}^{2} )}{{\sum }^{i} ( {IR}_{i} ⋆ {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated as Equation 7: Flowrate(effective)=Flowrate(nominal)*(RV(FM Calibrated)/RV(FM Sample)) (EQ7). Processing of the flow marker peak is done via the PolymerChar GPCOne™ Software. Acceptable flowrate correction is such that the effective flowrate is within +/−0.7% of the nominal flowrate.

### Gel Permeation Chromatography (GPC) —Propylene-Based Polymers

A high temperature Gel Permeation Chromatography (GPC) system, equipped with Robotic Assistant Deliver (RAD) system for sample preparation and sample injection, is used. The concentration detector is an Infra-red detector (IR4) from Polymer Char Inc. (Valencia, Spain). Data collection is performed using Polymer Char DM 100 Data acquisition box. The system is equipped with an on-line solvent degas device from Agilent. The column compartment is operated at 150 °C. The columns are four, Mixed A LS 30 cm, 20 micron columns. The solvent is nitrogen (N2) purged, 1,2,4-trichlorobenzene (TCB), containing approximately “200 ppm” of 2,6-di-t-butyl-4-methylphenol (BHT). The flow rate is 1.0 mL/min, and the injection volume is 200 μl. A “2 mg/mL” sample concentration is prepared by dissolving the sample in N2 purged and preheated TCB (containing 200 ppm BHT), for 2.5 hours at 160 °C, with gentle agitation.

The GPC column set is calibrated by running twenty narrow molecular weight distribution polystyrene (PS) standards. The molecular weight (MW) of the standards range from 580 to 8,400,000 g/mol, and the standards are contained in six “cocktail” mixtures. Each standard mixture has at least a decade of separation between individual molecular weights. The equivalent polypropylene molecular weight of each PS standard is calculated using the following equation (1), with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N.Y. Hellman, P. M. Muglia, Macromolecules, 4, 507 (1971)):

$${M}_{P P} = {( \frac{{K}_{P S} {M}_{P S}^{{a}_{PS} + 1}}{{K}_{P P}} )}^{\frac{1}{{a}_{P P} + 1}} ,$$

where M_{PP} is PP equivalent MW, M_{PS} is PS equivalent MW. The log K and a values of Mark-Houwink coefficients for PP and PS are listed below in Table A.

TABLE A

| Polymer | a | logK | Polymer | a | logK |
|---|---|---|---|---|---|
| Polypropylene | 0.725 | −3.721 | Polystyrene | 0.702 | −3.900 |

A logarithmic molecular weight calibration is generated using a fourth order polynomial fit as a function of elution volume. Number average and weight average molecular weights are calculated according to the following equations:

$${M}_{n} = \frac{{\sum }^{i} W {f}_{i}}{{\sum }^{i} ( \frac{W {f}_{i}}{{M}_{i}} )} ,$$

$${M}_{w} = \frac{{\sum }^{i} ( W {f}_{i} * {M}_{i} )}{{\sum }^{i} ( W {f}_{i} )} ,$$

where wfi and Mi, are the weight fraction and molecular weight of elution component i, respectively (note, MWD=Mw/Mn).

### Melt Index

The melt index (I2) of an ethylene-based polymer is measured in accordance with ASTM D-1238, condition 190 °C/2.16 kg. The melt flow rate (MFR) of a propylene-based polymer is measured in accordance with ASTM D-1238, condition 230 °C/2.16 kg.

### Shear Adhesion Failure Temperature (SAFT)

Shear Adhesion Failure Temperature (SAFT) was measured according to ASTM D 4498, with a 500 gram weight, using a Chem instruments OSI-8 programmable oven. Each test sample was initially equilibrated at 40 °C in the oven for 10 minutes and the oven temperature was increased at an average rate of 0.5 °C/minute. The temperature at which the adhesive bond fails was recorded. Each test sample was in a shear mode configuration with the 500 gram weight.

Each SAFT test sample was prepared using two sheets of “60 g/m2” Kraft paper, and each sheet was “6 in.×12 in. (152 mm×305 mm)” in dimensions. On the bottom sheet, lengthwise, and separated by a gap of one inch (25 mm), were adhered, in parallel fashion, two “1.75 in or 2 in (45 mm or 51 mm)” wide strips of a one sided, pressure-sensitive tape, such as masking tape. The two strips of tape were placed, such that the “one inch gap” ran lengthwise, down the center of the bottom sheet.

The adhesive composition (first composition) to be tested was heated to 170 °C (338 °F), and then drizzled in an even manner down the center of the “one inch gap,” formed between the two strips of tape. Then, before the composition could unduly thicken, a bonded paper template was quickly formed as follows. A rod rode immediately down the bottom sheet, leveling the adhesive composition within the gap. This rod was shimmed with a strip of the same tape on each side of the gap. After the pass of this first rod, a second sheet of the Kraft paper was aligned to, and laid on top of, the bottom sheet, and a second rod rode immediately down this top sheet, to form a bonded paper template. Overall, the first rod evenly spread the composition in the gap region between the tape strips, and the second rod evenly compressed the second sheet over the top of the gap region and over the top of the tape strips. Within the bonded paper template, a single one inch (25.4 mm) wide strip of the adhesive composition bonded the bottom and top paper sheets. The paper template was cut crosswise into strips of “one inch (25.4 mm)” in width” and “three inches (76.2 mm)” in length, to form test samples. Each test sample had a “one inch×one inch” adhesive bond area in the center, and a bond thickness of about 8 to 10 mils (0.008 to 0.010 inch). Each test sample was cured using one of two curing profiles, in air, either at room temperature (see a) or in a damp atmosphere (see b), as follows: a) cure at 22 °C, 50% RH, for 7, 16 or 21 days or longer, b) cure at 35 °C, 85% RH, for 7 days. Each cured test sample was then subject to the SAFT testing, as noted above. For each cured composition, two test samples were tested, and the average failure temperature recorded.

### EXPERIMENTAL

### Reagents and Polymer

Reagents and Polymer are shown in Table 1.

TABLE 1
Reagents and Polymers

| Ingredient | | Chemical Description, Chemical formula, or | |
|---|---|---|---|
| Type | Product Name | Structure | Source |
| Polymer 1 | AFFINITY GA | Density: 0.878 g/cm3; Brookfield Viscosity @ | Dow |
| | 1000R | 177 °C (350 °F): 13,000 mPa • s; Approx. Melt Index: | |
| | | 660 g/10 min (190 °C, 2.16 kg weight)), see U.S. | |
| | | Pat. No. 7,199,180 (footnote to Table 1); Tm = 68 °C, | |
| | | Tg = −58 °C, % cryst. = 20%; MAH-functionalized | |
| | | ethylene-based polymer. | |
| Epoxy silane | 2-(3,4- Epoxycyclohexyl)- ethyltriethoxysilane | 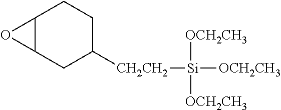 | TCI |
| | | CAS: 10217-34-2 | |
| Tackifier | ESCORES 5400 | Mn (g/mol): 400 g/mol, MWD 1.6-1.7, Melt | ExxonMobil |
| | | Viscosity @ 320 °F (160 °C): 800 mPa • s, Tg: 126 °F | |
| | | (55.2 °C), Cycloaliphatic hydrocarbon resin | |
| Tackifier | HRR-100 | Soft point: 100 °C, specific gravity: 1.12, Mn | KOLON |
| | | (g/mol): 400, Mw (g/mol): 700, MWD: 1.8, Silane | INDUSTRIES |
| | | modified hydrocarbon resin | |
| Polymer stabilizer 1 | IRGANOX 1010 | 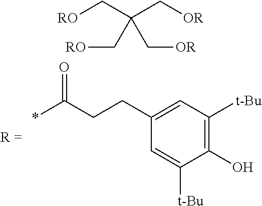 | BASF |
| | | CAS: 6683-19-8 | |
| Polymer- | P-ES3 | | |
| based | | | |
| epoxy | | | |
| silane | | | |

For the AFFINITY GA 1000R polymer, after a long storage time, in air, usually all or most of the anhydride groups convert to acid groups, as seen by FTIR. Thus, the AFFINITY GA 1000R was thermally treated at 180 °C, for 15-20 minutes, with stirring, to completely converts the acid group into anhydride groups (anhydride treating). The conversion can be monitored by FTIR. Herein “AFFINITY GA 1000R—Acid” in the tables below indicates AFFINITY GA 1000R without anhydride treating, while “AFFINITY GA 1000R—Anhydride” is the polymer after anhydride treating.

### Preparation of Polymer-Based Epoxy Silanes

The preparation of four polymer-based epoxy silanes are provided below. See also U.S. Pat. No. 9,562,149.

### Polymer-Based Epoxy Silane 1 (P-ES1)

A silanol-terminated methylvinylsiloxane dimethylsiloxane copolymer (80% by weight), with a viscosity of 20 mm²/s, and comprising mainly α,ω-hydroxy-terminated siloxane with some α-hydroxy-ω-methoxy-terminated siloxane, was reacted with 20% (by weight) 3-glycidoxypropyltrimethoxysilane, in the presence of potassium silanolate, at 100 °C, for one hour, to produce a reaction product containing at least one epoxy group, at least one alkenyl group and at least one alkoxy group in its molecule. At least 80% (by mole) of the epoxy groups from the glycidoxypropyltrimethoxysilane were incorporated in the reaction product, which also contained siloxane chains from the silanol-terminated polysiloxane.

### Polymer-Based Epoxy Silane 2 (P-ES2)

A silanol-terminated methylvinylsiloxane dimethylsiloxane copolymer (80% by weight), with a viscosity of 20 centiStokes, comprising α,ω-hydroxy-terminated siloxane and α-hydroxy-ω-methoxy-terminated siloxane, was reacted with 20% (by weight) methyl-(3-glycidoxypropyl)diethoxysilane, in the presence of potassium silanolate, at 100 °C, for one hour, to produce a reaction product containing at least one epoxy group, at least one alkenyl group and at least one alkoxy group in its molecule.

### Polymer-Based Epoxy Silane 3 (P-ES3)

A silanol-terminated methylvinylsiloxane dimethylsiloxane copolymer (50% by weight), with a viscosity of 20 mm²/s, and comprising α,ω-hydroxy-terminated siloxane and α-hydroxy-ω-methoxy-terminated siloxane, was reacted with 50% (by weight) β-(3,4-epoxycyclohexyl)ethyltrimethoxysilane, in the presence of potassium silanolate, at 100 °C, for one hour, to produce a reaction product containing at least one epoxy group, at least one alkenyl group and at least one alkoxy group in its molecule.

### Polymer-Based Epoxy Silane 4 (P-ES4)

A silanol-terminated methylvinylsiloxane dimethylsiloxane copolymer (45.5% by weight), with a viscosity of 20 mm²/s, and comprising α,ω-hydroxy-terminated siloxane and α-hydroxy-ω-methoxy-terminated siloxane, was reacted with 45.5% (by weight) 3-glycidoxypropyltrimethoxysilane and 9% (by weight) methylvinyldimethoxysilane, in the presence of potassium silanolate, at 100 °C, for one hour, to produce a reaction product containing at least one epoxy group, at least one alkenyl group and at least one alkoxy group in its molecule.

### First Composition

The first compositions are shown in Table 2 below.

### Preparation of First Composition Containing the “AFFINITY GA 1000R—Anhydride”

For each composition, the corresponding components, as shown in Table 2, except for the crosslinker (epoxy-silane or polymer-based epoxy silane), were weighed into a stainless steel container (250 mL), which was placed in an oven, and heated at a temperature of 180 °C (oven temp.), for 30-60 minutes, until the composition was melted. The composition was then melt blended, at a temperature from 180-200 °C, for 15 minutes, with a “Paravisc style” mixing head, running at 90-150 rotations per minute (rpm). The crosslinker was added, and the composition was stirred for 10 minutes at 180-200 °C.

The viscosity stability of each first composition (uncured) was examined by measuring the melt viscosity of the composition over time. The compositions were also cured and examined by SAFT. Results are shown in Table 2.

### Preparation of First Composition Containing the “AFFINITY GA 1000R—Acid”

The components of the composition (CE 3), as shown in Table 2, were weighed into the stainless steel container, and melt blended, at a temperature from 180-200 °C, for 15 minutes, with the “Paravisc style” mixing head, running at 90-150 rotations per minute (rpm). The composition gelled during this mixing stage.

### Cure of the First Composition (see Table 2, CE 1, CE 2 and IE 1-IE 5)

A SAFT test sample was made for each composition—see Test Methods section above. Each first composition was cured in air using one of two curing profiles, room temperature (see a) or in a damp atmosphere (see b), as follows: a) cure at 22 °C, 50% RH, for 7, 16 or 21 days or longer, b) cure at 35 °C, 85% RH, for 7 days. The cohesion of each crosslinked composition was determining using the SAFT test. Results are shown in Table 2. For the above damp curing, an oven temperature is represented at 35 °C; however, the test sample quickly equilibrated to the oven temperature in less than 10 minutes. Also, the temperature of 22 °C was that of the air temperature in a controlled lab environment. The % RH in the oven was controlled by a built-in humidity monitoring device, and the % RH at 22 °C was also controlled by a similar device.

### Summary of Results

The results showed that the examples (IE1, IE2, IE3, IE4 and IE5), containing the polymer-based epoxy silane as the cross-linker, had excellent high temperature viscosity stability after 120 °C for four hours. For CE3, the acid group reacted with epoxy silane and resulted in a gel, which indicated that anhydride was needed for the high temperature stability of the first compositions. In comparison with the benchmark (CE1), the SAFT of the examples (IE-IE5), after both damp and room temperature curing, showed significant improvement, which suggested that each cured composition had a high degree of crosslinking. Moreover, the examples (IE1-IE5) are greener in nature relative to CE2, labeled as “may cause skin or eye irritation” (due to the epoxy silane). Therefore, the inventive compositions are well suited for hot melt adhesive (HMA) applications.

TABLE 2
First Compositions and Properties

| Components | SI Units | | CE1 | CE2 | CE3 | IE1 | IE2 | IE3 | IE4 | IE5 |
|---|---|---|---|---|---|---|---|---|---|---|
| AFFINITY GA 1000R-Acid (1.2 wt %) | g | | | | 70 | | | | | |
| AFFINITY GA 1000R-Anhydride (1.2 wt %) | g | | 70 | 70 | | 70 | 70 | 70 | 70 | 70 |
| ESCORES 5400 | g | | 30 | 30 | 30 | 30 | 30 | 30 | | |
| HRR-100 | g | | | | | | | | 30 | 30 |
| IRGANOX 1010 | g | | 0.50 | 0.50 | 0.50 | 0.50 | 0.50 | 0.50 | 0.50 | 0.50 |
| 2-(3,4-Epoxycyclohexyl)ethyltriethoxysilane | g | | | 2.44 | | | | | | |
| P-ES3 | g | | | | 2.12 | 8.48 | 4.24 | 2.12 | 2.12 | 4.24 |
| Total | g | | 100.50 | 100.94 | 100.62 | 108.98 | 104.74 | 102.62 | 102.62 | 104.74 |
| Hazardous GHS label | | | Green | Warning | Green | Green | Green | Green | Green | Green |
| Brookfield Viscosity @ 120 °C (mPa · s) | 1 | hour | 41,571 | 43,671 | Gel | 48,890 | 63,686 | 61,887 | 48,690 | 36,832 |
| (% Δη(t)) | 2 | hours | 41,645 | 46,250 | | 58,288 | 66,286 | 65,886 | 53,189 | 40,731 |
| | | | (0.18) | (5.91) | | (19.22) | (4.08) | (6.45) | (9.24) | (10.59) |
| | 3 | hours | 40,451 | 50,789 | | 60,487 | 71,685 | 70,685 | 54,688 | 45,530 |
| | | | | (16.30) | | (23.72) | (12.56) | (14.22) | (12.32) | (23.62) |
| | 4 | hours | 40,235 | 53,189 | | 62,287 | 77,184 | 76,284 | 57,588 | 49,669 |
| | | | | (21.79) | | (27.40) | (21.19) | (23.26) | (18.27) | (34.85) |
| SAFT (Damp curing, 35 °C, 85% RH) (°C) | 7 | days | 72.9 | 135.4 | — | >170 | >170 | 117.4 | >170 | >170 |
| | | | | (3 days) | | | | | | |
| SAFT (22 °C, 50% RH) (°C) | 7 | days | 72.9 | — | — | 95.2 | 95.5 | 97.1 | 102.9 | 99.8 |
| | 16 | days | 72.9 | 109.1 | — | >170 | 121.1 | 112.4 | 122.2 | 133.2 |
| | 21 | days | 72.9 | — | — | — | >170 | — | >170 | >170 |

| | |
|---|---|
| (31 days) | (31 days) |

Gel-viscosity approached infinity. No viscosity stability.
(% Δη(t)) = [(η(t) − η1)/η1] × 100, and where η(t) is the melt viscosity after t hours at 120 °C, and ηl is the melt viscosity after 1 hour at 120 °C.
Warning-maybe a skin/eye irritant.

1. A first composition comprising at least the following components a and b:
a) an anhydride functionalized olefin-based polymer;
b) a polymer-based epoxy silane comprising the following i) and ii):
i) at least one epoxy group selected from the following ia) through ic):
ia) 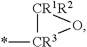
where R1, R2 and R3 are each independently H or an alkyl, and the asterisk (*) represents the remainder of the polymer-based epoxy silane,
ib) 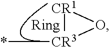
where R1 and R3 are each independently H or an alkyl, the term “Ring” represents a ring structure comprising ≥5 carbon atoms, and the asterisk (*) represents the remainder of the polymer-based epoxy silane, or
ic) a combination of ia) and ib);
ii) at least one siloxane group selected from the following iia) through iic):
iia) 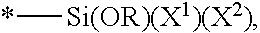
where X1 and X2 are each independently an alkyl group or an alkoxy group, R is an alkyl group, and the asterisk (*) represents the remainder of the polymer-based epoxy silane,
iib) 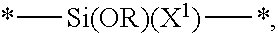
where X1 is an alkyl group or an alkoxy group, R is an alkyl group, and each asterisk (*) independently represents the respective remainder of the polymer-based epoxy silane; or
iic) a combination of iia) and iib); and
wherein the polymer-based epoxy silane comprises ≥2 silicon atoms.

2. The first composition of claim 1, wherein the polymer-based epoxy silane further comprises one or more of the following chemical groups a) through i):
a) —(CR¹R²—CR³R⁴)—, where each of R¹, R², R³, R⁴ is independently H or an alkyl; b) —(SiR¹R²—O)—, where each of R1, R2 is independently an alkyl; c) —(Si(R)(CR¹=CR²R³))—, where R is an alkyl, and each of R1, R2, R3 is independently H or an alkyl; d) —(CR¹R²—CR³(CR⁴=CR⁵R⁶))—, where each of R1, R2, R3, R4, R5, R6 is independently H or an alkyl; e) amide; f) ester; g) urethane; h) —(CR1R2-CR3R4)-, where each of R1, R2, R3 is independently H or an alkyl, and R⁴ is an aryl group; or i) any combination thereof; and
wherein each chemical group is derived from one or more monomers; and when present, each chemical group is present in at least two repeating units within the polymer-based epoxy silane.

3. The first composition of claim 1, wherein the polymer-based epoxy silane comprises at least one of the following structures T1a through T1c:
T1a) 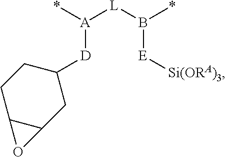
where D is a hydrocarbylene or a heterohydrocarbylene; E is a hydrocarbylene or a heterohydrocarbylene; A is —(CR1R2-CR3)- or —(O—SiR4)-, where R1, R2, R3 are each independently H or an alkyl, and R4 is an alkyl; B is —(CR5R6-CR7)- or —(O—SiR8)-, where R5, R6, R7 are each independently H or an alkyl, and R8 is an alkyl; and wherein at least one of D, E, A or B comprises at least one Si atom; RA is an alkyl, L is a divalent linker group; and each asterisk (*) independently represents the respective remainder of the polymer-based epoxy silane;
T1b) 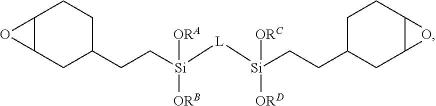
where RA, RB, RC and RD are each independently an alkyl, and L is a divalent linker group;
T1c) a combination of T1a and T1b.

4. The first composition of claim 1, wherein the polymer-based epoxy silane comprises one of the following structures T3a1, T3a2, T3a3, T3a4, T3a5 or T3a6: 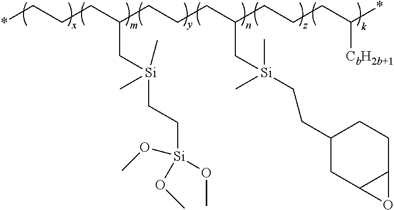
T3a1), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane; 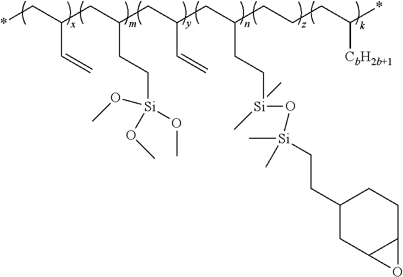
T3a2), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane; 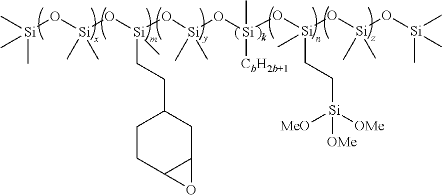
T3a3), where b is a number from 1 to 20, m is a number from 1 to 10, n is a number from 1 to 10, each of x, y, z and k is independently a number from 1 to 300; 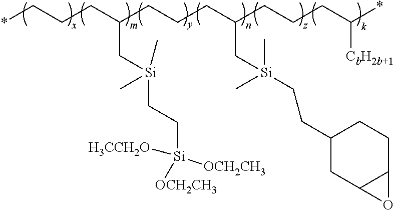
T3a4), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane; 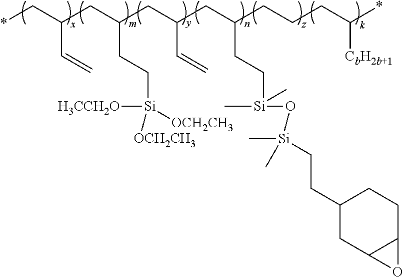
T3a5), where b is a number from 1 to 20, m is a number from 1 to 10, n is a number from 1 to 10, each of x, y, z and k is independently a number from 1 to 1000, and each asterisk (*) independently represents the respective remainder of the polymer-based epoxy silane; 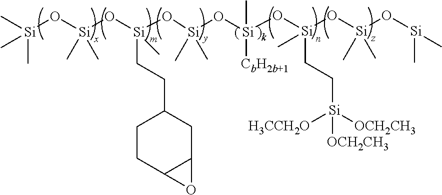
T3a6), where b is a number from 1 to 20, m is a number from 1 to 10, n is a number from 1 to 10, each of x, y, z and k is independently a number from 1 to 300.

5. The first composition of claim 1, wherein component a is an anhydride-functionalized ethylene-based polymer, or an anhydride-functionalized propylene-based polymer.

6. The first composition of claim 1, wherein component a is an anhydride-functionalized ethylene-based polymer.

7. The first composition of claim 1, wherein component a has a density from 0.860 g/cc to 0.920 g/cc.

8. The first composition of claim 1, wherein the first composition further comprises a tackifier (component c).

9. The first composition of claim 1, wherein the weight ratio of component a to component b is from 2.0 to 40.

10. The first composition of claim 8, wherein the first composition comprises from 80.0 wt % to 100.0 wt % of the sum of components a, b and c, based on the weight of the first composition.

11. The first composition of claim 1, wherein the first composition comprises from 50.0 wt % to 100.0 wt % of the sum of components a and b, based on the weight of the first composition.

12. The first composition of claim 1, wherein the first composition has a percent increase in melt viscosity at 120 °C (% Δη4 at 120 °C) from 10% to 45%, and where η4 is the melt viscosity after 4 hours at 120 °C, and η1 is the melt viscosity after 1 hour at 120 °C.

13. The first composition of claim 1, wherein the first composition, after 7 days at η2 °C, 50% RH, in air, has SAFT value from 80 °C to 200 °C.

14. The first composition of claim 1, wherein the first composition, after 7 days at 35 °C, 85% RH, in air, has SAFT value from 100 °C to 250 °C.

15. A process to form a composition comprising a crosslinked olefin-based polymer formed from the first composition of claim 1, said process comprising at least the following steps A) and B):
A) mixing together at least the components a and b to form the first composition;
B) exposing the first composition to moisture to form the crosslinked olefin-based polymer.

16. The process of claim 15, wherein step A takes place at a temperature from 120 °C to 200 °C.

17. The process of claim 15, wherein step A takes place at a relative humidity (% RH) from 10% to 60%.

18. The process of claim 15, wherein step B takes place at a temperature from 20 °C to 100 °C.

19. The process of claim 15, wherein step B takes place at a percent relative humidity (% RH) from 40% to 100%.

20. An article comprising at least one component formed from the first composition of claim 1.
